(19) United States
(12) Patent Application Publication
(10) Pub. No.: US 2019/0228321 A1
(43) Pub. Date: Jul. 25, 2019

(54) Inferring Home Location of Document Author

(71) Applicant: Runtime Collective Limited, Brighton (GB)

(72) Inventors: Dan Chalmers, Brighton (GB); Hamish Ivor Anderson Morgan, Brighton (GB); Guilherme Pombo, Brighton (GB)

(21) Appl. No.: 15/875,765

(22) Filed: Jan. 19, 2018

(51) Int. Cl. G06N 5/04; G06F 17/30; G06K 9/00; G06K 9/62; G06F 17/21; G06Q 50/00; G06F 17/18; G06N 3/08; G06N 99/00

(52) U.S. Cl. CPC G06N 5/04; G06F 17/30241; G06F 17/30722; G06K 9/00442; G06N 99/005; G06F 17/21; G06Q 50/01; G06F 17/18; G06N 3/08; G06K 9/6218

(57) ABSTRACT

Social media data including a plurality of documents including social media posts is received. Using an ensemble of predictive models and the received data, a plurality of candidate home locations for an author is determined. The plurality of candidate home locations are represented as geolocation spatial data probability distributions. Using the plurality of candidate home locations, a final predicted home location label for the author is determined. The determined final predicted home location label is provided. Related apparatus, systems, techniques and articles are also described.

### TECHNICAL FIELD

The subject matter described herein relates to inferring a home location of a document author, for example, a home location of an author of social media posts.

### BACKGROUND

In some social media communities, posts (e.g., documents) are generated by users. These posts can include express indications of the user location during or at the time the post is submitted. Some users may also provide a location in their biography associated with the social media community. These locations are typically represented as a name, which can be considered a label. For example, locations can include records of unique ID, name, and/or can include a description of the location (e.g., continent, country, state, city, and the like). Locations can be organized in a hierarchy, for example, “the city of Brighton is part of the country U.K.” by allowing a place to have a “parent” record.

But labels (e.g., names) may not be static, unique, or universally accepted location identifiers. For example, the city of “Brighton” is a city within the United Kingdom (U.K.) but Brighton is not a unique name. In addition, borders can change. Countries can invade each other and split up. Within countries administrative boundaries can be changed. Places can change name. Places can merge. New towns can be built. New colloquial names can emerge to reflect changes in population. People may continue to use old names, shortenings and miss-spellings despite official decree.

### SUMMARY

In an aspect, social media data including a plurality of documents including social media posts is received. Using an ensemble of predictive models and the received data, a plurality of candidate home locations for an author is determined. The plurality of candidate home locations are represented as geolocation spatial data probability distributions. Using the plurality of candidate home locations, a final predicted home location label for the author is determined. The determined final predicted home location label is provided.

One or more of the following features can be included in any feasible combination. For example, the documents can include a plurality of first documents having associated author location and a plurality of second documents without associated author location. Determining the plurality of candidate home locations can include: determining, using a first predictive model and the plurality of first documents, a first candidate home location of the author; determining, using a second predictive model and based on textual features of content of the second posts using the plurality of second documents, a second candidate home location for the author; determining, using a third predictive model and an interaction graph that represents interactions among social media users some of which have associated known home locations, a third candidate home location of the author; and determining, using a fourth predictive model and based on a self-declared home location, a fourth candidate home location of the author. The first candidate home location, the second candidate home location, the third candidate home location, and the fourth home location can be represented as geolocation data probability distributions.

The first predictive model can estimate author home location by clustering documents having associated geographical information regarding the location of the author at a time the document was published. The second predictive model can include a feedforward artificial neural network model that maps sets of input data onto a set of output data. The second predictive model can include multiple layers of nodes in a directed graph, with each layer fully connected to an adjacent layer, and a plurality of the nodes can include a nonlinear activation function.

The third predictive model can include a spatial label propagation model including a bi-directional network of author interactions. The third predictive model can estimate author home location as a geometric median of other social media users that the author interacts with.

The fourth predictive model can include a gazetteer that maps between location labels and a geospatial coordinate system.

The second predictive model can be trained using an output of the first model and an output of the fourth model. The third predictive model can be trained using an output of the first model and an output of the fourth model.

Geolocation spatial data probability distributions can characterize probabilities that a given candidate home location is located across a range of latitudes and a range of longitudes.

At least one of the receiving, first determining, second determining, and providing is performed by at least one data processor forming part of at least one computing system.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system block diagram illustrating an example system that infers social media author's home locations;

FIG. 2 is a process flow diagram illustrating an example process of inferring an author's home location; and

FIG. 3 is a process flow diagram illustrating an example process of determining candidate home locations.

Like reference symbols in the various drawings indicate like elements.

### DETAILED DESCRIPTION

The current subject matter can include inferring a home location of an author of social media posts using data retrieved from a social media network. Social media data can include documents (e.g., posts) and associated metadata, for example, twitter posts and associated author identities can be retrieved. The social media data can be retrieved for a large population (e.g., many users/authors). Portions of the data can include express statements of author location (e.g., geotagged tweets) at the time of posting while other portions of the data may not specify location of the author. Using the social media data, a “home” geolocation of each author can be inferred using an ensemble of models.

Rather than directly classifying or inferring a label (e.g., name) of the home location, the home location can be treated as a random variable. Accordingly, the ensemble of models according to some aspects of the current subject matter can infer (e.g., output) home location information in the form of a probability distribution function (e.g., whose value at any given sample (or point) in the sample space (the set of possible values taken by the random variable) can be interpreted as providing a relative likelihood that the value of the random variable would equal that sample). The probabilities can then be compared to a model or mapping of labels (e.g., names) to geolocation coordinates (e.g., latitude and longitude).

The ensemble can include a geo-clustering model that determines a home location for users having authored content with express location information (e.g., geotagged tweets) by clustering the locations. The output of this first model can be used to train one or more additional models in the ensemble, which can be utilized to infer a home location for social media data in which there is no explicit associated location information. A second model can be trained by the output of the first model and can use textual features of the social media data to make an inference between content of the social media data (e.g., tweet) and home location (e.g., people are likely to post about location specific topics). A third model can use an interaction graph, which can include a graph representing interactions among social media users (e.g., the home locations of some of which have been previously inferred), to infer home location. A fourth model can infer location based on a user's self-declared location such as in a biographical location field. The output of the fourth model can be used to train other models in the ensemble.

The ensemble of models can output geolocation data in the form of probability distribution functions (e.g., a probability a user is at a certain latitude/longitude), which can include bounding boxes (and/or other shapes), to represent user home location, which can then be compared to a model of home location labels (e.g., names and which can also include geospatial shapes) in order to determine a home location label (e.g., name). This approach can be contrasted to systems that classify directly to the label (e.g., model outputs a home location label (e.g., name) directly from social media documents and metadata).

Determining a home location label (e.g., name) of an author of a social media post can include a number of challenges. For example, borders change over time so while a location may not change (in a geospatial coordinate sense), its label (e.g., name) may change due to a change in label (e.g., name). Sometimes the places identified will not match neatly to the places in the database. Maybe a person lives on a new development on the edge of town, maybe approximations in the data create gaps, or they may post on the train in-between places.

In addition, locations do not fit neatly into hierarchies. For example, different countries have different location hierarchies. Large countries like U.S.A. have notions such as “state”, which may not be present in all countries. The definitions of- and implications arising from each level in the hierarchy can vary from place to place. In many cases these variations arise in the interpretation of the data, although their presentation as equivalent in a hierarchy does not encourage this. As another example, the place of Brighton in the hierarchy has recently changed: the county that contained it is no longer part of the tree. This challenge also occurs when considering concepts that mix political and physical geography, such as continents, where some countries span multiple continents. A single is-a-part-of relation may not be appropriate in this instance.

Some aspects of the current subject matter change the primary model of a place, from an ID referring to a database of place labels (e.g., names), to a coordinate space. By representing a person's location as a shape (e.g., box) around where they post from (e.g., home, the office, the train, favorite pub, and the beach) it can be possible to sidestep the issue of imperfect matches to inconstant borders.

When a query of a social media analysis system wants to know about people in Brighton, the system can load the current model of Brighton into the query and find places that match. When a shop wants to know about potential customers within a mile, a query can be written with a radius around that point. When a regional sales team's region boundaries change, the query can change with it, even if that change arises from changes in political boundaries.

Where social media users describe a place label (e.g., name) in many languages, aliases can be used while still mapping to the same coordinate space. The use of spatial queries rather than textual queries can create a significant simplification where queries need to account for different languages, misspellings, use of non-ASCII characters that can be written by non-native or non-local speakers who may not know about spelling variations or colloquial names.

In other words, defining geography using the politics of naming and ownership can be challenging for a system that works (e.g., provides analysis and query results) across communities, languages, and time. Reducing the notion of location to coordinate systems can enable separate handling of geography and naming. Handling naming and place separately can be advantageous because the associated data set can be processed more easily.

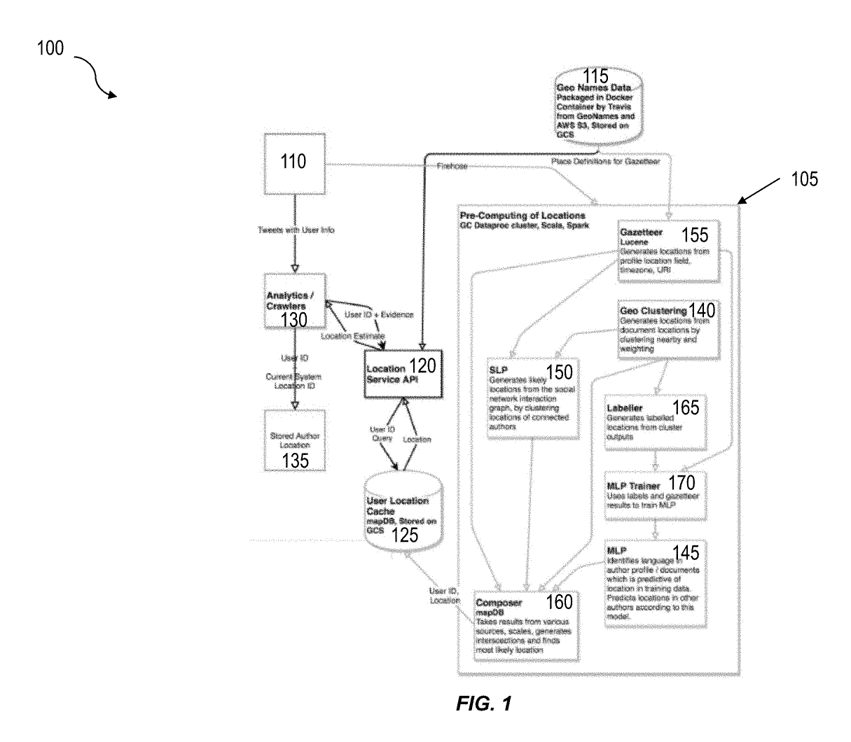

FIG. 1 is a system block diagram illustrating an example system 100 that can infer social media author's home locations. Rather than directly classifying or inferring a label (e.g., name) of the home location, the system 100 can treat home locations as random variables, determines home locations as probability distribution functions, which can then be compared to a model or mapping of labels (e.g., names) to geolocation coordinates (e.g., latitude and longitude) to determine a home location label (e.g., name).

Example system 100 can include a location pre-computation component 105 that can interface (e.g., indirectly or directly) to a social media site 110, database of place definitions 115, a location service API 120, and a user location cache 125. Location pre-computation component 105 can infer user home locations and store those locations within the user location cache 125 in the form of geospatial shapes (e.g., bounding boxes). In some implementations, labels (e.g., names) can also be stored. Location service API 120 can, given a user ID, perform a query of the user location cache 125 to return an estimate of the user home location in the form of a geospatial shape as well as a label (e.g., name). Location pre-computation component 105 thus enables analytics/crawlers 130 to perform queries on social media sites 110 utilizing location service API 120 in order to determine author home location (in the form of a geospatial shape), which can be stored as a geospatial shape in a database 135 of author home locations. In some implementation, a label of the author home location can also be stored. In some implementations, analytics/crawlers 130 can act as an HTTP client to location-service API 120.

In some implementations, the location pre-computation component 105 can interface to a social media site 110 through multiple layers of abstraction.

Location precomputation component 105 can include an ensemble of positive models including a first model 140, a second model 145, a third model 150, and a fourth model 155. While four models are described, in some implementations, additional or fewer models can be utilized. Models 140, 145, 150, 155 can infer candidate home locations for an author and can output those candidate home locations in the form of a geospatial probability or likelihood. For example, candidate home locations can be represented as probability distribution functions that vary over a geospatial coordinate system such as latitude or longitude, although in some implementations, other geospatial coordinate systems can be utilized.

Outputs of models 140, 145, 150, 155, can be provided to a composer 160 that can take the candidate home location probabilities/likelihoods and output a label (e.g., name) of the home location. Outputs of models 140, 145, 150, 155 can be in the form of probability distribution functions (e.g., a probability a user is at a certain latitude/longitude), which can include bounding boxes (and/or other shapes), to represent candidate home locations. Outputs of models 140, 145, 150, 155 can include respective associated scores that reflect a measure of confidence or like characteristic of the output of the model. Composer 160 can scale the score of the candidate home locations and determine a most likely home location using the scaled score and the probability distribution functions. Scaling can include re-weighting the score output produced by each model to normalize the score output and make them comparable. In some implementations, the scaling can be performed heuristically (e.g., using a score weighting factor).

In some implementations, composer 160 can determine an intersection of the probability distribution functions output from models 140, 145, 150, 155, and an associated combined score.

Composer 160 can compare the most likely home location or the intersection of likely home locations against a model or mapping of geospatial coordinates to labels (e.g., names). The model or mapping of home location labels (e.g., names) can also be represented as geospatial shapes enabling conversion from, e.g., latitude and longitude, to a location string (e.g., name or label). Composer 160 can thus determine intersections between bounding boxes (and/or other shapes) representing probabilities or likelihood of home location and bounding boxes (and/or other shapes) representing location labels (e.g., names). In some implementations, composer 160 can provide the most probable label (e.g., name) and/or associated probabilities as output.

In some implementations, scaled candidate home location probabilities can be compared to the model or mapping of geospatial coordinates to labels (e.g., names) so that multiple potential home location labels can be provided. In some implementations, associated probabilities can also be provided with the multiple home location labels (e.g., names). (For example, composer 160 can output label “Hove” with probability of 72% and “Kemptown” with probability of 28%.) The approach of having models classify to probabilities within a geospatial coordinate system then comparing those probabilities to a model or mapping of geospatial coordinates to labels (e.g., names) can be contrasted to systems that classify directly to the label (e.g., model outputs a home location label (e.g., name) from social media documents and metadata).

In some implementations, first model 140 can include a geo-clustering model that generates home location candidates from a collection of documents having associated location information (e.g., location information of the document author when the document is posted to the social media site 110). An example of a document having associated location information can include a geo-tagged tweet, which can include a tweet that contains geographical information regarding the location of the user at the time the tweet was written and/or posted (e.g., the tweet includes metadata containing a latitude and longitude for the place where the tweet was posted).

In some implementations, second model 145 can infer home location using textual features in documents. For example, authors located in similar areas may discuss similar location-specific topics, e.g., people from a given location are likely to talk about location specific things. For example, in Brighton “BHAFC” and “The Seagulls” are over-represented, and form useful features. In some implementations, second model 145 includes a multilayer perceptron that identifies textual features (e.g., language) in an author's profile and/or documents to predict candidate home location. A multilayer perceptron (MLP) is a feedforward artificial neural network model that maps sets of input data onto a set of appropriate outputs. An MLP can include multiple layers of nodes in a directed graph, with each layer fully connected to the next one. Except for the input nodes, each node can be a neuron (or processing element) with a nonlinear activation function. MLP can utilize a supervised learning technique called backpropagation for training the network. MLP can be considered a modification of the standard linear perceptron and can distinguish data that are not linearly separable.

In some implementations, third model 150 can infer an author's home location based on other authors or individuals with which they interact on social media since people tend to interact with individuals with similar home locations. In some implementations, third model 150 can include a spatial label propagation (SLP) model. An SLP can include a bi-directional network of user's interactions and enables inference of a user's home location using the geometric median of other user's she/he interacts with.

In an example implementation, a social network graph is constructed using bi-directional @mentions, which mitigates the effect of one-sided relationships such as celebrities or meme pages. An example implementation of an SLP can examine each node in the @mention graph and estimate a user's location as the friend location that minimizes the distance to other friends. The median distance can be used to handle outliers. A threshold of @mentions can be established to ensure quality (e.g., only attempt to infer a user that has over a certain number of interactions). A dispersion threshold can be used to ensure quality (e.g., only attempt to infer a user's location if the distance dispersion between the people the user interacts with is under a certain threshold).

In some implementations, fourth model 155 can determine a respective candidate home location using author self-declared information. For example, the fourth model 155 can include a gazetteer that generates candidate home locations from a user's profile location field, time zone, uniform resource identifier (URI), and the like. A gazetteer can include a geographical dictionary or directory. A gazetteer can contain information concerning the geographical makeup; social statistics; physical features of a country, region, or continent; and the like. Gazetteers can be considered to provide a “mapping” from location labels (e.g., names) to latitudes and longitudes, and vice versa. The fourth model 155 can receive geolocation labels (e.g., names and from location definitions) from database 115.

In some implementations, output from one or more models may be used to train another model. For example, location precomputation component 105 can include a labeler 165 and an MLP trainer 170 that trains the second model 145 using an output of the first model 140 and fourth model 155 as the supervisory signals. Labeler 165 can receive the candidate home location from the first model 140 and generate labelled location information from the candidate home location of the first model 140. The label and the candidate home location generated by the fourth model 155 can be received by the MLP trainer 170. MLP trainer 170 can train the second model 145 using the output from labeler 165 and the output of the fourth model 155 as supervisory signals and use as input, the same social media input as used by the first model 140 and fourth model 155.

Inter-model training can be useful where, for example, a particular model is effective under certain circumstances. For example, the fourth model 155 can generate a candidate home location from a user's self-declared home location. Since this can be considered a reliable determination (e.g., if a user self-declares their home location, it can be a reliable estimate of home location), the output of the fourth model 155 can be used as supervisory signal to train the second model 145 and third model 150. The second model 145 and third model 150 can benefit from this training and can then be probative in situations where a user does not have a self-declared home location.

Similarly, third model 150 can be trained by using an output of the first model 140 and fourth model 155 as supervisory signals.

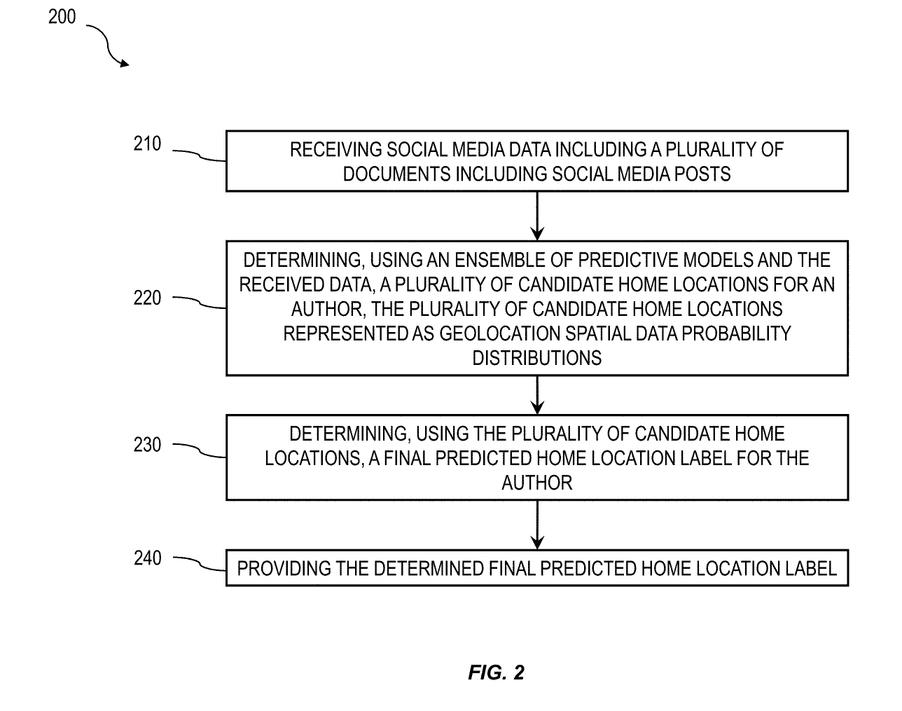

FIG. 2 is a process flow diagram illustrating an example process 200 of inferring an author's home location. Rather than directly classifying or inferring a label (e.g., name) of the home location, the process 200 treats home locations as random variables and determines home locations as probability distribution functions, which can then be compared to a model or mapping of labels (e.g., names) to geolocation coordinates (e.g., latitude and longitude) to determine a home location label (e.g., name).

At 210, social media data is received. The social media data can include documents having associated author location at the time the document was posted to a social media site. The social media data can include documents without the associated author location. The social media data can include social media posts, for example, tweets.

At 220, candidate home locations for the author can be determined using an ensemble of predictive models and the social media data. The ensemble of predictive models can output location as geolocation spatial probabilities such as probabilities for a range of geospatial location coordinates (e.g., latitudes and longitudes).

At 230, a final predicted home location label for the author can be determined. The final predicted home location label for the author can be determined by, for example, scaling the candidate home locations and determining a most likely home location. The most likely home location can be compared against a model or mapping of geospatial coordinates to labels (e.g., names). The model or mapping of home location labels (e.g., names) can also be represented as geospatial shapes enabling conversion from, e.g., latitude and longitude, to a location string (e.g., name or label). Intersections between bounding boxes (and/or other shapes) representing probabilities or likelihood of home location and bounding boxes (and/or other shapes) representing location labels (e.g., names) can be determined. In some implementations, the most probable label (e.g., name) and/or associated probabilities can be determined.

At 240, the final predicted home location label can be provided. The providing can include, for example, storing the final predicted home location label. The storing may be within, for example, user location cache 125 for use during a query by a social media analytical process.

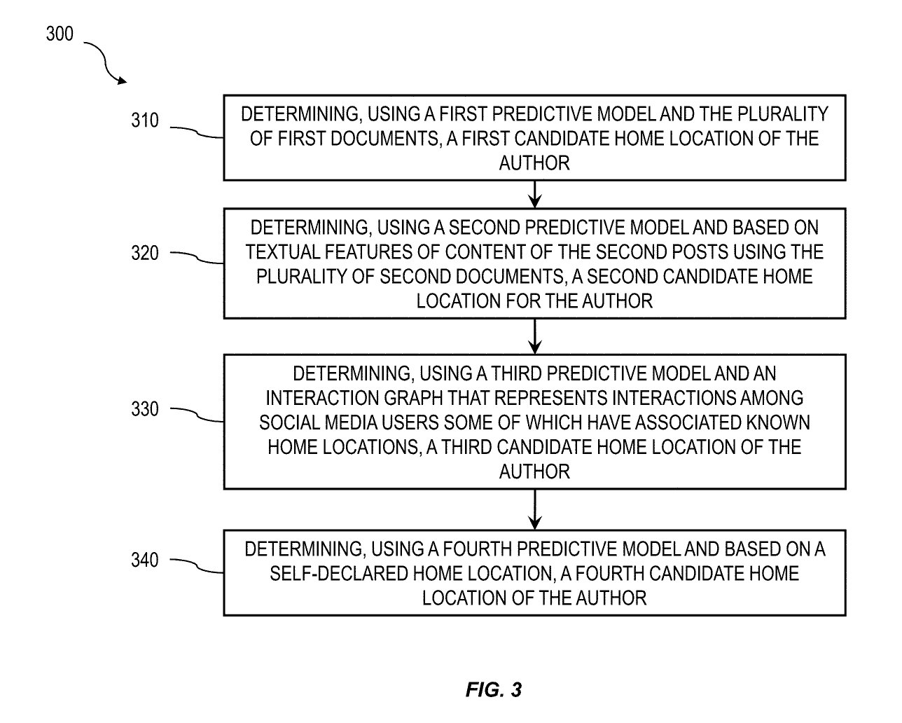

FIG. 3 is a process flow diagram illustrating an example process 300 of determining candidate home locations. Rather than directly classifying or inferring a label (e.g., name) of the home location, the process 300 treats home locations as random variables and determines home locations as probability distribution functions or other measures of likelihood.

At 310, a first candidate home location of the author can be determined using a first predictive model and social media documents (e.g., posts) having associated location information. The first predictive model can estimate author home location by clustering locations of the author at a time the document was published for documents having associated geographical information.

At 320, a second candidate home location for the author can be determined using a second predictive model. The determination can be based on textual features of content of social media documents (e.g., posts) that do not have associated location information available. The second predictive model can include a feedforward artificial neural network model that maps sets of input data onto a set of output data. The second predictive model can include multiple layers of nodes in a directed graph with each layer fully connected to an adjacent layer and the nodes including a nonlinear activation function.

At 330, a third candidate home location of the author can be determined using a third predictive model and an interaction graph that represents interactions among social media users some of which have associated known home locations. The third predictive model can includes a spatial label propagation model including a bi-directional network of author interactions. The third predictive model can estimate author home location as a geometric median of other social media users that the author interacts with.

At 340 a fourth candidate home location of the author can be determined using a fourth predictive model and based on a self-declared home location of the author. The fourth predictive model can include a gazetteer that maps between location labels and a geospatial coordinate system.

Each of the candidate home locations can be represented as geolocation data probability distributions.

In some implementations, the second predictive model can be trained using an output of the first model and an output of the fourth model. In some implementations, the third predictive model can be trained using an output of the first model and an output of the fourth model.

Although a few variations have been described in detail above, other modifications or additions are possible. For example, the current subject matter is not limited to using Twitter posts as a data source, but can be applied to other social media data sources such as Instagram, Social Gist, Sina Weibo, and Images. The current subject matter can be applied in other contexts, such as for author models across sources (e.g., when it is known that, for example, a twitter account and an Instagram account are the same author, then one can determine the author location of one from the other), document level location (e.g., determine location of the author at the time of authorship, as contrasted with location of residence), subject of document location (e.g., determining what the document is talking about), and the like.

In addition, large and small enterprises alike can require social data to be filtered by location. Larger organizations can do this to distribute social data to the relevant market level teams. Smaller organizations can do this to filter out irrelevant non-local noise when performing market or branding analysis.

The subject matter described herein provides many technical advantages. For example, by handling naming and place separately, it can be easier to perform data science over a data set. The current subject matter can provide more reliable location information, which can be used globally and across multiple regions. The current subject matter can improve location determinations, especially in non-Western parts of the world.

Some implementations of the current subject matter can resolve author location with improved accuracy and with greater recall than some current systems. In some implementations, locations of users can be inferred with high precision and good recall, results from query-level geo-filtering can be improved, results from dashboard-level geo-filtering can be improved, and improvements can extend to multiple languages. Improved location inferencing can allow global enterprise customers to actually deploy globally across markets; allow users to get good quality location-filtered data (and trust it); allow users to better target their queries, making their work more efficient; allow users to better segment and gain insights because there is more and better quality city level data to analyze; and the like.

Some implementations of the current subject matter can enable enterprise social listening, including enabling segment by market and city since many multinationals are organized by market, and target cities for their marketing efforts. Some implementations of the current subject matter can enable media planning including agency media planning, which may frequently focus on targeting advertisements to specific cities (DMA or “designated marketing areas”).

Some implementations of the current subject matter can be tuned for precision, but with high recall; compatible with existing indexed location data; language agnostic; cope with Super bowl style peaks without being a bottleneck in the analytic/crawler pipeline; and maintain precision and recall over time, with a defined process to update the provided models.

Some implementations of the current subject matter can be implemented in a manner that is decoupled from the analytic/crawler pipeline. Inference can be performed offline, with locations for Twitter profiles being generated as part of a batch process. This can allow location inferencing to perform predictably, regardless of load.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores. In some implementations, the current subject matter can be provided as a scalable stateless micro service.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving social media data including a plurality of documents including social media posts;
determining, using an ensemble of predictive models and the received data, a plurality of candidate home locations for an author, the plurality of candidate home locations represented as geolocation spatial data probability distributions;
determining, using the plurality of candidate home locations, a final predicted home location label for the author; and
providing the determined final predicted home location label.

2. The method of claim 1, wherein the documents include a plurality of first documents having associated author location and a plurality of second documents without associated author location, wherein determining the plurality of candidate home locations includes:
determining, using a first predictive model and the plurality of first documents, a first candidate home location of the author;
determining, using a second predictive model and based on textual features of content of the second posts using the plurality of second documents, a second candidate home location for the author;
determining, using a third predictive model and an interaction graph that represents interactions among social media users some of which have associated known home locations, a third candidate home location of the author; and
determining, using a fourth predictive model and based on a self-declared home location, a fourth candidate home location of the author;
wherein the first candidate home location, the second candidate home location, the third candidate home location, and the fourth home location are represented as geolocation data probability distributions.

3. The method of claim 2, wherein the first predictive model estimates author home location by clustering documents having associated geographical information regarding the location of the author at a time the document was published.

4. The method of claim 2, wherein the second predictive model includes a feedforward artificial neural network model that maps sets of input data onto a set of output data, the second predictive model including multiple layers of nodes in a directed graph, with each layer fully connected to an adjacent layer, a plurality of the nodes including a nonlinear activation function.

5. The method of claim 2, wherein the third predictive model includes a spatial label propagation model including a bi-directional network of author interactions, the third predictive model estimates author home location as a geometric median of other social media users that the author interacts with.

6. The method of claim 2, wherein the fourth predictive model includes a gazetteer that maps between location labels and a geospatial coordinate system.

7. The method of claim 2, wherein the second predictive model is trained using an output of the first model and an output of the fourth model.

8. The method of claim 2, wherein the third predictive model is trained using an output of the first model and an output of the fourth model.

9. The method of claim 1, wherein geolocation spatial data probability distributions characterize probabilities that a given candidate home location is located across a range of latitudes and a range of longitudes.

10. The method of claim 1, wherein at least one of the receiving, first determining, second determining, and providing is performed by at least one data processor forming part of at least one computing system.

11. A system comprising:
at least one data processor;
memory storing instructions which, when executed by the at least one data processor, causes the at least one data processor to perform operations comprising:
receiving social media data including a plurality of documents including social media posts;
determining, using an ensemble of predictive models and the received data, a plurality of candidate home locations for an author, the plurality of candidate home locations represented as geolocation spatial data probability distributions;
determining, using the plurality of candidate home locations, a final predicted home location label for the author; and
providing the determined final predicted home location label.

12. The system of claim 11, wherein the documents include a plurality of first documents having associated author location and a plurality of second documents without associated author location, wherein determining the plurality of candidate home locations includes:
determining, using a first predictive model and the plurality of first documents, a first candidate home location of the author;
determining, using a second predictive model and based on textual features of content of the second posts using the plurality of second documents, a second candidate home location for the author;
determining, using a third predictive model and an interaction graph that represents interactions among social media users some of which have associated known home locations, a third candidate home location of the author; and
determining, using a fourth predictive model and based on a self-declared home location, a fourth candidate home location of the author;
wherein the first candidate home location, the second candidate home location, the third candidate home location, and the fourth home location are represented as geolocation data probability distributions.

13. The system of claim 12, wherein the first predictive model estimates author home location by clustering documents having associated geographical information regarding the location of the author at a time the document was published.

14. The system of claim 12, wherein the second predictive model includes a feedforward artificial neural network model that maps sets of input data onto a set of output data, the second predictive model including multiple layers of nodes in a directed graph, with each layer fully connected to an adjacent layer, a plurality of the nodes including a nonlinear activation function.

15. The system of claim 12, wherein the third predictive model includes a spatial label propagation model including a bi-directional network of author interactions, the third predictive model estimates author home location as a geometric median of other social media users that the author interacts with.

16. The system of claim 12, wherein the fourth predictive model includes a gazetteer that maps between location labels and a geospatial coordinate system.

17. The system of claim 12, wherein the second predictive model is trained using an output of the first model and an output of the fourth model.

18. The system of claim 12, wherein the third predictive model is trained using an output of the first model and an output of the fourth model.

19. The system of claim 11, wherein geolocation spatial data probability distributions characterize probabilities that a given candidate home location is located across a range of latitudes and a range of longitudes.

20. A non-transitory computer program product storing instructions, which when executed by at least one data processor of at least one computing system, implement operations comprising:
receiving social media data including a plurality of documents including social media posts;
determining, using an ensemble of predictive models and the received data, a plurality of candidate home locations for an author, the plurality of candidate home locations represented as geolocation spatial data probability distributions;
determining, using the plurality of candidate home locations, a final predicted home location label for the author; and
providing the determined final predicted home location label.
